(19) United States
(12) Patent Application Publication
(10) Pub. No.: US 2023/0275274 A1
(43) Pub. Date: Aug. 31, 2023

(54) BIPOLAR BATTERY PLATE ASSEMBLY AND RELATED MECHANICAL COUPLING TECHNIQUE

(71) Applicant: Gridtential Energy, Inc., Santa Clara, CA (US)

(72) Inventor: Daniel Jason Moomaw, Santa Clara, CA (US)

(21) Appl. No.: 18/099,576

(22) Filed: Jan. 20, 2023

Related U.S. Application Data
(63) Continuation of application No. 16/862,682, filed on Apr. 30, 2020, now abandoned.
Application No. 16/862,682 is a continuation-in-part of application No. PCT/US18/58223, filed on Oct. 30, 2018.
(60) Provisional application No. 62/579,548, filed on Oct. 31, 2017.

(51) Int. Cl. H01M 10/18; H01M 50/121; H01M 50/105

(52) U.S. Cl. CPC H01M 10/18; H01M 50/121; H01M 50/105

(57) ABSTRACT

A battery assembly, such as a bipolar battery assembly, generally includes a first casing portion comprising an optically-absorbing region, and a second casing portion comprising an optically-transmissive region. The first and second features form a welded joint. Fabrication of such an assembly can include physically mating the first casing portion with the second casing portion, and irradiating, such as using a laser, the optically-absorbing region defining the first feature through the optically-transmissive region to form the welded joint.

### CLAIM OF PRIORITY

This patent application is a continuation of Moomaw, U.S. patent application Ser. No. 16/862,682, titled “BIPOLAR BATTERY PLATE ASSEMBLY AND RELATED MECHANICAL COUPLING TECHNIQUE,” filed on Apr. 30, 2020 (Attorney Docket No. 3601.028US1), which is itself a continuation-in-part and claims the benefit of priority of (1) Moomaw, International Application PCT/US2018/058223, filed Oct. 30, 2018 and published as WIPO publication WO/2019/089604; and (2) Moomaw, U.S. Provisional Patent Application No. 62/579,548, titled “BIPOLAR BATTERY PLATE ASSEMBLY AND RELATED MECHANICAL COUPLING TECHNIQUE,” filed on Oct. 31, 2017 (Attorney Docket No. 3601.025PRV), the benefit of each of which is hereby presently claimed, and the entirety of each of which is presently incorporated herein by reference.

### FIELD OF THE DISCLOSURE

This document pertains generally, but not by way of limitation, to battery assemblies, such as lead-acid battery assemblies, and more particularly to assembly techniques and casing configurations that can be used for bipolar battery assemblies.

### BACKGROUND

Bipolar batteries generally include battery cells that are electrically connected in a series configuration. More specifically, each cell generally includes two electrodes, a positive active mass, a negative active mass, an electrolyte reservoir, and a casing or “package.” The term bipolar can refer to use of an electrode configuration, or “bipole,” positioned within the battery such that positive active material is located on one surface of a conductive substrate, and a negative active material is located on an opposing surface. Generally, current flows uniformly through a cross section of the bipole from one active material to the other. The current then moves through an electrolyte reservoir and into another bipole-active material assembly. A number or “count” of bipoles can establish the total voltage of the battery. Regardless of cell count, the ends of the bipolar battery assembly can include a monopole structure at each end, such as a positive-polarity monopolar plate at a first end of the assembly, and a negative-polarity monopolar plate at an opposite end of the assembly. The opposing (e.g., outward-facing) surfaces of these monopoles can serve as respective electrical connections to provide a location or node for battery terminals. Electrolyte regions between the bipolar plates are generally hermetically sealed from each other, due to the generally series flow of current through the bulk of each bipolar current collector assembly.

### SUMMARY

A casing or “package” for a bipolar battery can provide hermeticity between electrolyte regions. For example, bipolar plate assemblies or “bipoles” can be arranged in individual frames that are coupled together and sealed. A modular configuration allows for adjustment of a total battery voltage and the frame assembly can both provide and isolate seals on opposite sides of the frame (e.g., on opposite sides of each casing segment) to ensure a failure of one seal does not result in failure of the other. If a frame-to-frame seal is exposed as a portion of the exterior of a battery housing, a breach can result in acidic electrolyte being allowed into the surrounding environment.

Casing segment materials can include polymer materials. For example, a thermoplastic material such as acrylonitrile butadiene styrene (ABS), polypropylene, polycarbonate, or one or more other materials can be used. A melting temperature of the polymers mentioned above may constrain sealing techniques used for these material systems. In one approach, a seal can include a gasket. Gasket materials can be sourced as in other industrial applications and such gaskets can be made from corrosion-immune materials such as rubber or polytetrafluoroethylene (PTFE). Seals are generally loaded or compressed to provide hermeticity. However, challenges can exist because such compression can be damaging to other portions of the bipole assembly, such as leading to fracture of certain bipole materials or otherwise complicating a fabrication or assembly process. Compression may also be difficult to maintain over an expected life of a battery. Surface preparation of surfaces to be sealed can help suppress defects. For example, microvoids can develop between the bipole and a gasket, allowing for ionic conductivity between cells.

Various sealing approaches can involve other techniques, other than gaskets. For example, adhesives, such as an epoxy, can be used to bond casing or frame segments and can provide a seal. Adhesives can provide a liquid form initially, allowing them to fill in voids in a bipole or packaging frame (e.g., between casing segments), helping to reduce or suppress the chances of an ionic leak. Adhesive dispensing equipment can be used to make the application of adhesives readily automated, such as can be used to improve seal quality or manufacturing consistency, as illustrative examples. Some adhesives tend to be costly and may provide only a short working life. Such a short working life can make assembly of stacks of framing segments problematic, such as for higher voltage bipolar battery assemblies including several stacked cells. Some adhesives are readily attacked by acidic solutions and may gradually degrade over prolonged exposure. This creates the potential for seal failure due to aging of the battery. Because certain adhesives are applied in liquid form, such adhesives can flow. More specifically, adhesive can be displaced out of a joint itself during compression and into the surroundings. This can lead to visually unappealing seals that may not be acceptable for a commercial product.

In yet another approach, an induction welding technique can be used. For example, metallic wires can be positioned between packaging frames in a bipolar assembly and also between the bipoles and the frames. The assembly can then be compressed and placed inside an inductive chamber or coil. By running a voltage through the coil, a magnetic field is created that generates heat within the metallic wires placed within the assembly. This heat causes the surrounding frame material to melt and creates a hermetic seal. Induction welding has proven to create very reliable seals. Induction welding can also present challenges. For example, specialized equipment for performing the welding can be expensive and the composition of the conductive wires may be restricted to provide compatibility with battery chemistry and to protect against contamination. Also, an inductive welding process generally involves using a bipole comprising a material having a similar melting point to that of a supporting frame, or a seal might not be achieved.

The present inventor has recognized, among other things, that a sealed battery cell can be fabricated using a laser welding. For example, a solid electrolyte battery can be assembled by combining a ceramic frame as a housing for the active material and two conductive sheets on either side of the ceramic frame. The conductive sheets can be use as terminals and can be bonded to the ceramic using laser welding. In another approach, laser welding can be used in fabrication of a bipolar plate assembly or “biplate” assembly. In one example of such an approach, a biplate assembly can be constructed including a lead foil and plastic frames that are laser welded together to create a hermetically sealed structure.

The present inventor has recognized, among other things, that each the techniques mentioned above can present challenges, particularly when used alone. A market for bipolar battery assemblies continues to grow, providing opportunities for other assembly and seal techniques to be used. Generally, in the examples described herein, portions of a battery casing (e.g., casing segments) can be welded together by irradiating an optically-absorbing portion of a first casing segment by transmitting optical energy through an optically transmissive portion of a second casing segment. Such irradiation can include use of a laser, to provide a welded joint between the first and second casing segments. One or more external features of the first or second casing segments can facilitate one or more of alignment or support of an output of a laser. A seal or gasket can be included to provide redundancy or to further protect a bipolar plate substrate from shock or damage.

A battery assembly, such as a bipolar battery assembly, generally includes a first casing portion comprising an optically-absorbing region defining a first feature, and a second casing portion comprising an optically-transmissive region, the second casing portion defining a second feature, the second feature sized and shaped to mate with the first feature. The first and second features form a hermetic seal comprising a welded joint. Fabrication of such an assembly can include physically mating the first casing portion with the second casing portion, and irradiating, such as using a laser, the optically-absorbing region defining the first feature through the optically-transmissive region to form the welded joint. The first or second casing portions can include one or more casing segments that can support a battery plate, such as comprising a conductive substrate. A gasket or seal can be used such as to provide a further seal at or near a perimeter of the conductive substrate.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a side view (such as a section view) of an example comprising first and second casing segments and a biplate assembly, such as corresponding to a portion of a bipolar battery assembly.

FIG. 2 illustrates generally a side view (such as a section view) of an example comprising three casing segments and respective biplate assemblies, such as corresponding to a portion of a bipolar battery assembly, along with an alignment of a light source for performing welding.

FIG. 3 illustrates generally a side view (such as a section view) of an example comprising a stack of casing segments and end segments, such as comprising a portion of a bipolar battery assembly.

FIG. 4 illustrates generally a side view (such as a section view) of an example comprising casing segments and a valve port, such as comprising a portion of a bipolar battery assembly.

FIG. 5 illustrates generally a 6-cell bipolar battery assembly, such as fabricated using one or more techniques or configurations as shown and described in relation to other examples herein.

FIG. 6 illustrates generally a technique, such as a method, for forming a welded joint between casing segments of a battery assembly.

FIG. 7A illustrates generally a side view (such as a section view) of a bipolar battery assembly, such as can include end segments coupled (e.g., welded) to sidewalls.

FIG. 7B illustrates generally a side view (such as a section view) of a portion of the bipolar battery assembly of FIG. 7A.

FIG. 8 illustrates generally a 6-cell bipolar battery assembly, such as fabricated using one or more techniques or configurations as shown and described in relation to other examples herein, such as the examples of FIG. 7A and FIG. 7B.

### DETAILED DESCRIPTION

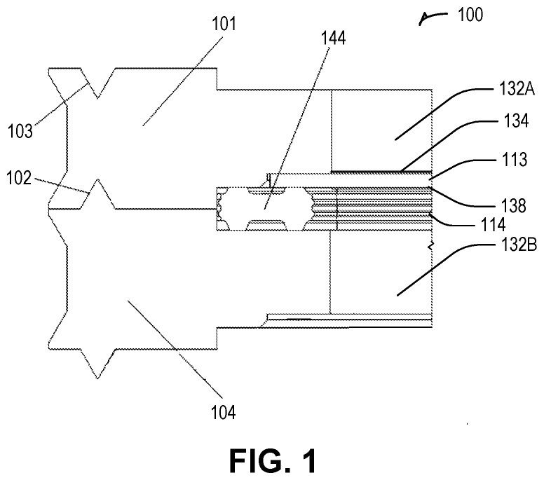

FIG. 1 illustrates generally a side view (such as a section view) of an example 100 comprising a first casing segment 101, a mating second casing segment 104, and a biplate 113 assembly. The first casing segment can include a portion or an entirety comprising an optically-transmissive material. For example, the first casing segment 101 can define features such as a feature 103 having a cross section sized and shaped to mate with a corresponding feature 102 on the second casing segment 104. The second casing segment 104 can include a portion or an entirety comprising an optically-absorbing material. For example, the first casing segment 101 can be optically transmissive in a region comprising the feature 103 or nearby the feature 103, and the second casing segment 104 can be optically absorptive in a region comprising the feature 102 or nearby the feature 102. Corresponding features 102 and 103 can provide a “tongue-and-groove” configuration having an interference fit and can form a hermetic seal comprising a welded joint around a perimeter of the first and second casing segments 101 and 104.

The tongue feature 102 and groove feature 103 shown in FIG. 1 are triangular in cross section. Such a cross section is illustrative, and other shapes can be used such as a rectangular tongue, a chamfered or beveled tongue, circular, radiused, or arced configurations, or other shapes. The groove feature 103 need not correspond exactly to the tongue feature 102. For example, the first casing segment 101 can define a groove feature 103 having one or more of a lateral width sufficient to provide an interference fit, or a depth sufficient to provide extra volume for melted material or overflow. As another illustrative example, a length of the tongue feature 102 can be 20% larger than a depth of the groove feature 103. This allows the tongue to melt and collapse during welding, creating material flow to fill-in imperfections and ensure a hermetic joint. The features 102 and 103 can extend around an entirety of the cross section of the first and second casing segments 101 and 104, respectively, such as where the casing segments are square or rectangular (e.g., defining a frame). In an example, corners of the features 102 and 103 along the perimeter of the casing segments 101 and 104 can be tightly radiused to be as small as possible (e.g., approaching a right angle).

Toward an interior region, the biplate 113 can be supported by a recessed portion or other feature defined by one or more of the first casing segment 101 or the second casing segment 104. For example, as shown in FIG. 1, the first casing segment 101 can support the biplate 113, such as defining a recessed feature (e.g., a lip or shelf), or respective stepped features, to support the biplate 113, along with a compliant seal (e.g., a gasket 114). The gasket 114 can be ribbed as shown in the side and end views, such as having a “double bead” cross section 144 as shown in FIG. 1. The gasket 114 can be made from a chemically resistant and compressible material such as ePTFE or a similar material, as an illustrative example. The gasket 114 can support the biplate 113 under compression, such as helping to balance loading of the biplate 113, preventing damage to the biplate 113 during fabrication or later use.

The first and second casing segments can define electrolyte and active material regions, such as a region 132A and a region 132B, between adjacent biplates. A first surface 134 of the biplate 113 can support a first active material having a first conductivity type (e.g., a lead paste), and an opposite second surface 138 of the biplate 113 can support a second, opposite conductivity type active material (e.g., a lead oxide paste). The biplate 113 can include a conductive substrate, such as comprising a metal plate or a silicon substrate, as illustrative examples. For example, the biplate 113 can include doped silicon, such as comprising at least one of monocrystalline or polycrystalline silicon. A purity of the silicon substrate can include at least a metallurgical-grade purity. In this manner, semiconductor-grade wafer substrates are not required.

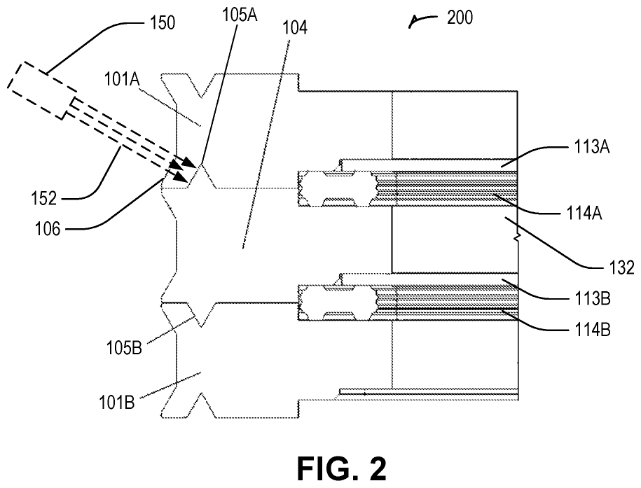

FIG. 2 illustrates generally a side view (such as a section view) of an example 200 comprising three casing segments and respective biplate assemblies 113A and 113B, such as corresponding to a portion of a bipolar battery assembly, along with showing an alignment of a light source 150 for performing welding. In FIG. 2, a first casing segment 101A is shown physically mated with a second casing segment 104. As in the example of FIG. 1, at least a portion of the first casing segment 101A can be optically transmissive at or nearby a region of joint 105A to be welded. The second casing segment 104 can be optically absorbing at or nearby the joint 105A. An angle of the joint 105A can correspond to an angle of an exterior feature 106 of the first or second casing segments 101A or 104, such as to facilitate alignment or support of an output of the light source 150. For example, an output of the light source 150 can abut the exterior feature 106 during a welding process, such as to maintain a surface of the output of the light source 150 in an orientation perpendicular to an angle of a face of the joint 105A to be welded. Placing the light source 150 closer to the joint 105A can enhance the welding process by providing greater optical energy (and hence energy for welding) locally at the joint 105A.

By angling an exterior surface of a casing segment such as corresponding to the feature 106, it is possible to maintain the light source 150 at a set Z-height and rotate the battery stack about the Z-axis to create a weld, such as around an entire perimeter. The weld enters the battery through an angled surface, penetrates the optically-transmissive first casing segment 101A is absorbed by the angled tongue surface within the joint 105A. In the examples herein, such as shown in FIG. 2, a welding process can take place sequentially with a single optical source, or contemporaneously, such as using one laser per optically-transmissive casing segment, or using multiple lasers, such as while the stacked assembly is maintained under compression.

Optical energy 152 emitted from the light source 150 (e.g., laser light) can be transmitted through an optically-transmissive portion of the first casing segment 101A to heat the joint 105B, such as by heating an optically-absorbing portion of the second casing segment 104 at a location of a “tongue” feature to form a welded joint. The optically-absorbing region of the second casing segment 104 is generally optically absorbing within a specified range of wavelengths overlapping with a corresponding range of wavelengths over which the second casing segment is optically transmissive, such as corresponding to an emission wavelength of the light source 150 (e.g., an infrared range of wavelengths). The approach and configuration shown in FIG. 2 can facilitate assembly of stacks of cells in a modular manner. For example, during a weld process, the first casing segment 101A, the second casing segment 104, and a third casing segment 101B can be held under compression. Such compression allows a tongue feature comprising a portion of the joint 105A to melt and can ultimately create a flush fit between the first casing segment 101A and the second casing segment 104.

Generally, the stack shown in the example 200 of FIG. 2 can be similar to FIG. 1, with the first and third casing segments 101A and 101B including optically transmissive regions at least nearby joints 105A and 105B. As in FIG. 1, the first biplate 113A can be supported by the first casing segment 101A and a gasket 114A, and the second biplate 113B can be supported by a second gasket 114B, and so on, as may be determined by a total count of cells to be provided to support a specified terminal voltage. A region 132 can be provided between adjacent biplates 113A and 113B, such as to provide a space for a solid or liquid electrolyte. For example, one or more of an absorbed glass mat (AGM) material or separator can be provided in the region 132, and the region 132 can also provide space for active material on opposite sides of the electrolyte.

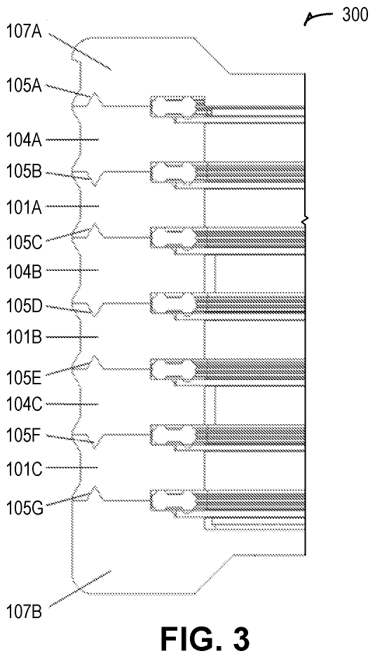

FIG. 3 illustrates generally a side view (such as a section view) of an example 300 comprising a stack of casing segments and end segments, such as comprising a portion of a bipolar battery assembly. As in the examples of FIGS. 1 and 2, the stack shown in FIG. 3 can include a series of welded joints, such as laser welded joints 105A, 105B, 105C, 105D, 105E, 105F, and 105G comprising mating features defined by respective casing segments. Certain casing segments can have optically-transmissive regions at or nearby the joints, such as casing segments 101A. 101B, and 101C, respectively mated to casing segments that can have optically-absorbing regions at or nearby the joints, such as casing segments 104A, 104B, 104C.

Segments comprising an “end cap” of the battery assembly can have a slightly different shape and can also comprise optically-transmissive or optically-absorbing regions. For example, a first end cap 107A can include at least an optically-transmissive region at or near the joint 105A. Similarly, an opposite second end cap 107B can include at least an optically-absorbing region at or near the joint 105G. For branding or other purposes (e.g., identifying different voltages or capacities), one or more of a color or opacity of respective segments can be varied. For example, a color code (e.g., a sequence of segments having different colors corresponding to different numerical values) or contrasting colors can be used to indicate to a user a capacity, chemistry, voltage, or application (e.g., marine vs. vehicular) of the battery assembly, or to indicate its source. As an illustrative example, transmissive segments such as the end caps 107A and 107B can be clear, and optically-absorbing segments such as casing segments 104A, 104B, 104C, and 107B can be colored.

Generally, biplate assemblies (such as the assemblies 113A and 113B shown in FIG. 2) can be stacked vertically with active materials until a specified battery terminal voltage is established. For example, in construction of a 6-cell battery as shown in FIG. 3, the end cap 107B can be laid first and followed by the casing segment 101C including a biplate assembly. Within the cell cavity created by the casing segment, a positive active material, a negative active material, and a separator can be placed. The next casing segment 104C can then be placed on top of the casing segment 101C, and so on, terminating with another end cap 107A. A total specified terminal voltage of the finished battery can be used to determine the number of cells that need to be stacked between the end caps 107A and 107B.

Once all components are stacked together, a compression force can be applied between the end caps 107A and 107B to bring all parts into close contact (e.g., physically mating the casing segments). This compression force can be maintained during the assembly process where each casing segment is laser welded to the next. The result is a welded and hermetically sealed battery stack with appropriate compression of active material for specified performance.

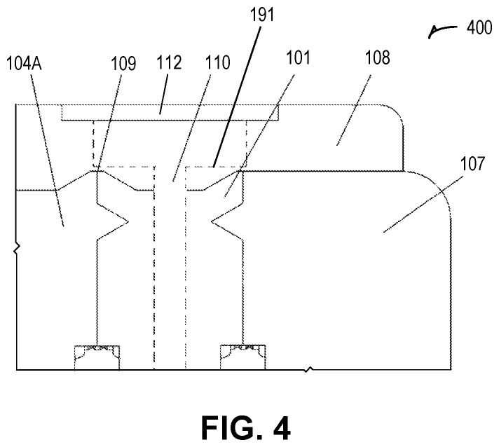

FIG. 4 illustrates generally a side view (such as a section view) of an example 400 comprising casing segments and a valve port 110, such as comprising a portion of a bipolar battery assembly. In the illustrative example of FIG. 4, a first casing segment 101 can be optically-transmissive, at least in regions corresponding to grooved features aligned with mating tongue features on a second casing segment 104A and an end cap 107. The second casing segment 104A and the end cap 107 can be optically absorbing, at least in regions where welded joints are to be formed when the first casing segment 101 is mated with the second casing segment 104A and the end cap 107. The valve port 110 can define an aperture or hollow region in communication with an electrolyte region between current collectors (e.g., monopolar or bipolar battery plates) supported by one or more of the first casing segment 101, the second casing segment 104A and the end cap 107. The valve port 110 can terminate in a valve block 108, such as providing a relief valve or cap 112, such as for a sealed lead-acid battery. The valve block 108 can also be welded to a stack comprising the first casing segment 101, the second casing segment 104A and the end cap 107, such as by irradiating an optically absorbing region of the end cap 107 or the second casing segment 104A from within the valve block 108, such as to form a weld at a location 109 or other locations.

In the example shown in FIG. 4, a seat 191 of the valve block 108 is defined by the valve block. In addition, or instead, the seat 191 can be provided by an extended portion of one or more casing segments such as the casing segment 101. In yet another example, the valve block 108 can be formed (e.g., fabricated) or otherwise unitized with casing segments such as one or more of segments 104A, 101, or end cap 107, or a laser weld to join adjacent casing segments can also form a portion of the valve block 108.

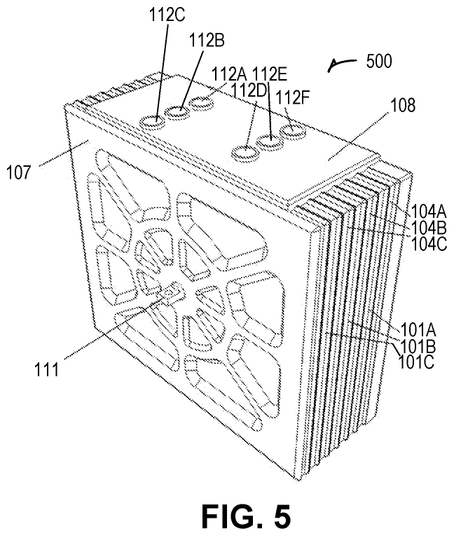

FIG. 5 illustrates generally a 6-cell bipolar battery assembly 500, such as fabricated using one or more techniques or configurations as shown and described in relation to other examples herein (e.g., such as having an internal construction like the example shown in FIG. 3). Respective first casing segments 101A, 101B, and 101C can be physically mated with corresponding second casing segments 104A, 104B, and 104C. End caps such as an end cap 107 can be mated with the last segment on each end of the battery. The battery assembly 500 can be placed in compression, and welded joints can be formed around the perimeter of the mated segments, such as using a laser supported or aligned using alignment features (e.g., ribbed regions corresponding to the exterior feature 106 as shown in FIG. 2). A valve block 108 can be attached to the battery assembly 500, such as welded using a laser welding technique from within one or more valve ports defined by the valve block 108. Relief valves or caps 112A, 112B, 112C, 112D, 112E, and 112F can be provided, such as sealing valve ports in communication with respective electrolyte regions between the casing segments. An electrical terminal 111 can be provided, such as electrically coupled to a monopolar plate supported by the end cap 107.

Generally, in the examples herein, such as the finished assembly 500 shown in FIG. 5, the components that make up the structure of a battery assembly have been laser-welded together to create a strong and hermetically-sealed package. The valve block 108 can also be welded to the battery assembly, such as to provide additional strength or rigidity for the assembly 500. The welds between the valve block 108 need not be in tension, whereas other weld locations may be mechanically loaded in tension. Various illustrative examples of battery assembly configurations can include a 6-cell, 12-cell, or a 24-cell arrangement to produce about 12V, about 24V, or about 48V terminal voltages for the battery assembly, assuming a lead-acid chemistry.

In an illustrative example, such as once a stack comprising the end cap 107 and casing segments 101A, 101B, 101C, 104A, 104B, and 104C has been fully welded around its perimeter, a compressive force can be removed. The stack can be oriented vertically and the valve block 108 an be added, such as using a technique or configuration as shown in FIG. 4. For additional strength, one or more joints can be formed at regular intervals along the cell frames and end caps. Laser light used for welding can penetrate a portion or an entirety of the thickness of the valve block 108 to reach a joint surface, in this case. In such an example, the valve block 108 can have a thickness that is reduced to permit efficient transmission of the laser light.

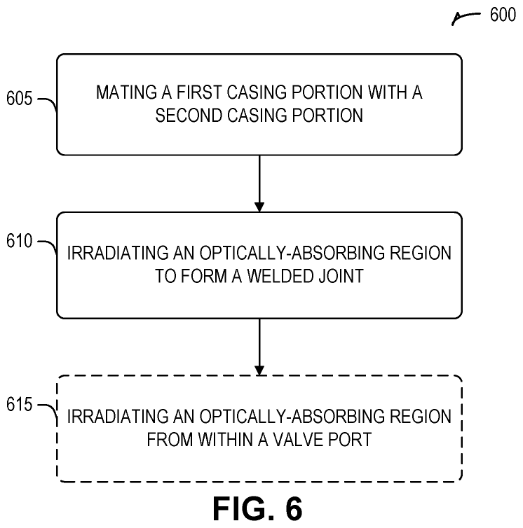

FIG. 6 illustrates generally a technique 600, such as a method, for forming a welded joint between portions of a battery assembly (e.g., a bipolar battery assembly). For example, at 600, a first casing portion can be physically mated with a second casing portion. The first casing portion (such as a casing segment, end segment, or sidewall) can include an optically-absorbing region defining a first feature (e.g., a tongue feature) and the second casing portion (such as a casing segment, end segment, or sidewall) can include an optically-transmissive region define a second feature (e.g., a groove feature). At 610, the optically-absorbing region defining the first feature can be irradiated to form a welded joint between the first and second features, such as using laser light passed through the optically-transmissive region.

Generally, the optically-absorbing region is optically absorbing within a specified range of wavelengths overlapping with a corresponding range of wavelengths over which the second casing segment is optically transmissive, the specified range of wavelengths including an optical wavelength used for the irradiating the optically-absorbing region. The laser light can include a wavelength within the specified range of wavelengths. In an example, one or more of the first or second casing portions can include an exterior feature to one or more of support or align an output of a light source used to irradiate the first and second casing segments to form the weld. A compliant seal such as a gasket can be applied to one or more of the first or second casing portions, such as to assist in one or more of protecting or supporting a biplate assembly housed by the first or second casing segments. Using the technique 600, a hermetic seal can be formed by a laser-welded joint. The compliant seal can provide redundancy to avoid leakage of an electrolyte from a cavity within the battery assembly. Such a weld and compliant seal configuration can also suppress leakage between adjacent sealed electrolyte regions.

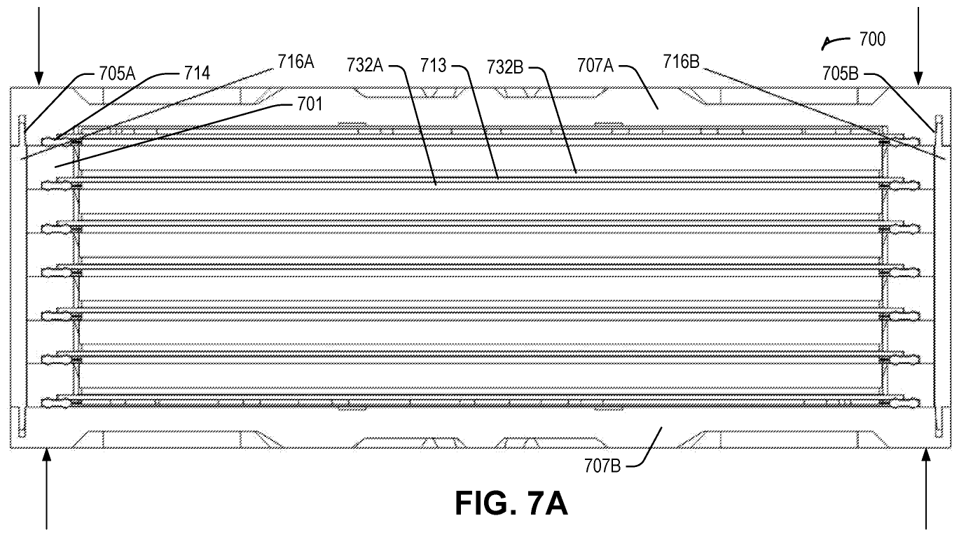

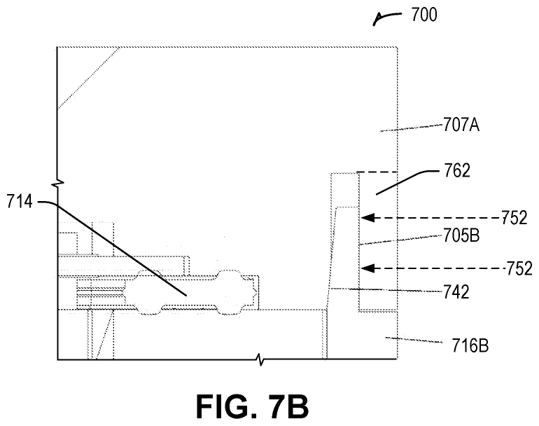

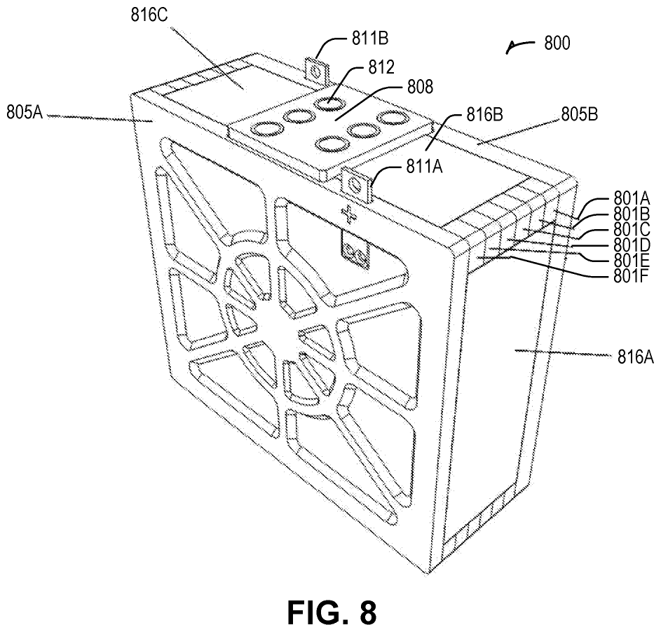

FIG. 7A illustrates generally a side view (such as a section view) of a bipolar battery assembly 700, such as can include end segments physically mated (e.g., welded) to sidewalls and FIG. 7B illustrates generally a side view (such as a section view) of a portion of the bipolar battery assembly 700 of FIG. 7A. The examples of FIG. 7A, FIG. 7B, and FIG. 8 can be combined with other structures or techniques described in this document, or the configuration of FIG. 7A. FIG. 7B, or FIG. 8 can be used as an alternative to other examples herein. Referring to FIG. 7A and FIG. 7B, the bipolar battery assembly 700 can include one or more bipolar battery plates such as a bipolar plate (“biplate”) 713 that can be supported by one or more casing segments such as a casing segment 701. The configuration of the biplate 713 and the casing segment 701 can be similar to other examples shown and described in this document, such as where the casing segment 701 supports the biplate 713 by a recessed portion or other feature defined by the casing segment 701 or an adjacent segment, or both. The casing segment 701 can support a compliant seal (e.g., a gasket 714), as shown and described in relation to other examples herein.

The biplate 713 can be conductively coupled to a first active material region 732A and a second active material region 732B, such as described elsewhere herein. In the examples of FIG. 7A and FIG. 7B, sidewalls such as a sidewall 716A and a sidewall 716B can be mechanically coupled to end segments 707A and 707B using joints 705A and 705B. As in the examples described above, a first casing portion such as the end segment 707A can be optically transparent, at least in a region 702 near the joint 705B, as shown in the detail of FIG. 7B, to allow incident optical energy to be transmitted through the end segment 707A to an optically-absorbing region of the sidewall 716B, or vice versa (e.g., the end segment 707A can include a protruding feature mating with a cavity in the sidewall 716B). Generally, the “tongue-and-groove” configuration shown in detail in FIG. 7B can provide an interference fit and can be used to form a hermetic seal comprising a welded joint around a perimeter of the battery assembly 700. For example, a tongue feature of the sidewall 716B can have a cross section defining at least one angled face 742 to provide an interference fit with a corresponding cavity within the end segment 707A. Such a cross section is illustrative, and other shapes can be used such as a rectangular tongue, a chamfered or beveled tongue, circular, radiused, or arced configurations, or other shapes such as a triangular cross section. The groove feature of the end segment 707A need not correspond exactly to the tongue feature of the sidewall 716B. For example, as described in relation to other examples herein, a cavity depth sufficient to provide extra volume for melted material or overflow can be provided. As another illustrative example, a length of the tongue feature can be 20% larger than a depth of the groove feature 103. The tongue-and-groove features can extend along an entirety of a cross section of the sidewall 716B.

Optical energy 752 emitted from the light source (e.g., laser light) can be transmitted through an optically-transmissive portion 762 of the end segment 707A to heat the joint 705B, such as by heating an optically-absorbing portion of the sidewall 716B at a location of a “tongue” feature to form a welded joint. The optically-absorbing region of the sidewall 716B is generally optically absorbing within a specified range of wavelengths overlapping with a corresponding range of wavelengths over which the second casing segment is optically transmissive, such as corresponding to an emission wavelength of the light source (e.g., an infrared range of wavelengths).

Generally, referring to FIG. 7A and FIG. 7B, sidewalls such as sidewall 716A and sidewall 716B can be physically mated and welded to end segments 707A and 707B to keep a stack of biplates captive. For example, the joints 705A and 705B can help to keep a compressive force applied to the stack as shown by the arrows in FIG. 7A. The configurations of FIG. 7A, FIG. 7B, and FIG. 8 do not require that individual casing segments be welded to each other as in other examples herein, but the techniques of FIG. 7A, FIG. 7B, and FIG. 8 could be combined with a technique where adjacent casing segments are welded together or otherwise mechanically adhered or fused as shown and described in relation to other examples herein.

FIG. 8 illustrates generally a 6-cell bipolar battery assembly 800, such as fabricated using one or more techniques or configurations as shown and described in relation to other examples herein, such as the examples of FIG. 7A and FIG. 7B. In FIG. 8, end segments 805A and 805B can be physically mated with sidewalls 816A, 816B, and 816C, such as using a welded joint. As mentioned elsewhere in other examples, other joints can be formed using optical energy to weld structures together, such as to attach a valve block 808 including respective caps such as a cap 812, to the battery assembly 800. Alternatively, the block 808 can be included as a portion of a unitized sidewall assembly (e.g., where sidewall 816B and 816C are part of a single assembly along with the block 808). In yet another example, the block 808 can be formed at least in part by one or more casing segments 801A, 801B, 801C, 801D, 801E, and 801F.

Casing segments 801A, 801B, 801C, 801D, 801E, and 801F need not be welded together using optical energy, because end segments 805A and 805B can provide structure when welded to sidewalls 816A, 816B and 816C, for example, to keep the casing segments 801A, 801B, 801C, 801D, 801E, and 801F captive (e.g., in compression along with intervening glass mats or separators). By contrast with the example of FIG. 5, terminals 811A and 811B are arranged at the edge of the end segments 805A and 805B, respectively, but the terminal configuration shown in FIG. 5 could also be used.

Each of the non-limiting examples below can stand on its own, or can be combined in various permutations or combinations with one or more of the other aspects or other subject matter described in this document.

Example 1 can include at least a portion of a battery assembly, such as bipolar battery assembly, comprising a first casing segment comprising an optically-absorbing region defining a first feature, and a second casing segment comprising an optically-transmissive region, the second casing segment defining a second feature, the second feature sized and shaped to mate with the first feature. The first and second features form a hermetic seal comprising a welded joint and the optically-absorbing region is optically absorbing within a specified range of wavelengths overlapping with a corresponding range of wavelengths over which the second casing segment is optically transmissive.

In Example 2, the subject matter of Example 1 includes an optically-transmissive region of the second casing segment defining the second feature.

In Example 3, the subject matter of any of Examples 1 or 2 includes a bipolar battery plate (biplate) supported by at least one of the first or second casing segments.

In Example 4, the subject matter of Example 3 includes a compliant seal located proximally to the biplate relative to the welded joint.

In Example 5, the subject matter of any of Examples 3 or 4 includes a biplate comprising a conductive substrate, a first active material located on a first surface of the conductive substrate, and a second active material located on a second surface of the conductive substrate opposite the first surface, the second active material having a polarity opposite the first active material.

In Example 6, the subject matter of any of Examples 1 through 5 includes that one of the first or second casing segments comprises a valve port, the valve port sized and shaped to permit a laser to irradiate an optically-absorbing region from within a valve block in communication with the valve port.

In Example 7, the subject matter of any of Examples 1 through 6 includes that one of the first or second casing segments comprises an end-segment of the battery assembly.

In Example 8, the subject matter of any of Examples 1 through 7 includes that the first and second features define a protruding triangular cross-section and a cavity having a mating triangular cross-section, respectively.

In Example 9, the subject matter of any of Examples 1 through 8 includes that the first and second casing segments comprise a polymer material.

In Example 10, the subject matter of any of Examples 1 through 9 includes that the first and second features provide an interference fit when mated.

Example 11 can include a technique, such as a method, such as can be used to fabricate a portion or an entirety of a battery assembly, such as a bipolar battery assembly. In Example 11, a method comprises physically mating a first casing segment comprising an optically-absorbing region defining a first feature with a second casing segment comprising an optically-transmissive region, the second casing segment defining a second feature, the second feature sized and shaped to mate with the first feature, and irradiating the optically-absorbing region defining the first feature through the optically-transmissive region to form a welded joint. The optically-absorbing region is optically absorbing within a specified range of wavelengths overlapping with a corresponding range of wavelengths over which the second casing segment is optically transmissive, where the specified range of wavelengths includes an optical wavelength used for the irradiating the optically-absorbing region.

In Example 12, the subject matter of Example 11 includes that the irradiating comprises using a laser to form the welded joint.

In Example 13, the subject matter of any of Examples 11 or 12 includes attaching a bipolar battery plate (biplate) to at least one of the first or second casing segments prior to irradiating the optically-absorbing region, the biplate comprising a conductive substrate, a first active material located on a first surface of the conductive substrate, and a second active material located on a second surface of the conductive substrate opposite the first surface, the second active material having a polarity opposite the first active material.

In Example 14, the subject matter of Example 13 includes applying a compliant seal to a perimeter of the biplate.

In Example 15, the subject matter of any of Examples 11 through 14 includes that one of the first or second casing segments comprises a valve port, and the method includes irradiating an optically-absorbing region from within a valve block in communication with the valve port.

In Example 16, the subject matter of any of Examples 11 through 15 includes that the first and second features define a protruding triangular cross-section and a cavity having a mating triangular cross-section, respectively.

In Example 17, the subject matter of any of Examples 11 through 16 includes that mating the first and second features comprises using an interference fit provided by the first and second features.

Example 18 can include a technique, such as a method, such as can be used to fabricate a portion or an entirety of a battery assembly, such as a bipolar battery assembly. In Example 18, a method comprises physically mating a first casing segment comprising an optically-absorbing region defining a first feature with a second casing segment comprising an optically-transmissive region, the second casing segment defining a second feature, the second feature sized and shaped to mate with the first feature, and attaching a bipolar battery plate (biplate) to at least one of the first or second casing segments, the biplate comprising a conductive substrate, a first active material located on a first surface of the conductive substrate, and a second active material located on the second surface of the conductive substrate opposite the first surface, the second active material having a polarity opposite the first active material. In Example 18, the method comprises laser welding the optically-absorbing region defining the first feature through the optically-transmissive region to form a welded joint between the first and second features. The optically-absorbing region is optically absorbing within a specified range of wavelengths overlapping with a corresponding range of wavelengths over which the second casing segment is optically transmissive, the specified range of wavelengths including an optical wavelength used for laser welding the optically-absorbing region.

In Example 19, the subject matter of Example 18 includes applying a compliant seal to a perimeter of the biplate.

In Example 20, the subject matter of any of Examples 18 or 19 includes that the first and second features define a protruding triangular cross-section and a cavity having a mating triangular cross-section, respectively.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first.” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method, comprising:
physically mating a first wall comprising an optically-transmissive material to a first end and a second end of a bipolar battery assembly, the first end and the second end comprising an optically-absorbing material; and
using a laser, irradiating the optically-absorbing materials of the first end and the second end through the optically-transmissive material to form welded joints, the optically-absorbing material optically absorbing within a specified range of wavelengths overlapping with a corresponding range of wavelengths over which the optically-transmissive material is optically transmissive, the specified range of wavelengths including an optical wavelength used for the irradiating the optically-absorbing material;
wherein the bipolar battery assembly comprises casing segments housing respective bipolar plate assemblies, the casing segments held in compression during the irradiating, the casing segments separate from the first wall;
wherein the welded joints formed between first wall and the first and second ends of the bipolar battery assembly, respectively, maintains the bipolar battery assembly in compression.

2. The method of claim 1, wherein the first and second ends comprise a first end segment and a second end segment, respectively, of a stack of the casing segments.

3. The method of claim 2, wherein the first and second end segments are fused to the stack of casing segments using respective joints separate from the welded joints formed between the first wall and the first and second ends.

4. The method of claim 3, wherein the respective joints fusing the first and second end segments to the stack comprise joints separate from the welded joints formed between the first wall and the first and second ends.

5. The method of claim 1, wherein the first end defines a feature to mate with a corresponding portion of the first wall.

6. The method of claim 5, wherein the feature comprises at least one of a cavity or a protrusion.

7. The method of claim 5, wherein the feature defines at least one face on which a corresponding face of the portion of the first wall is mated; and
wherein a respective welded joint is formed at the mating faces using the laser.

8. The method of claim 1, wherein respective ones of the casing segments are hermetically isolated from each other by respective joints separate from the welded joints formed between first wall and the first and second ends of the bipolar battery assembly.

9. The method of claim 2, wherein the respective joints comprise respective seals.

10. The method of claim 9, wherein the respective seals are formed using an adhesive.

11. The method of claim 1, wherein the first wall is amongst two or more side walls located on different sides of the battery assembly; and
wherein the two or more side walls maintain the bipolar battery assembly in compression using respective welded joints formed using laser irradiation.

12. A bipolar battery assembly, comprising:
a compressed stack of casing segments housing respective bipolar plate assemblies;
a first wall comprising an optically-transmissive material mated to a first end and a second end of a bipolar battery assembly, the first end and the second end comprising an optically-absorbing material; and
welded joints formed between first wall and the first and second ends of the bipolar battery assembly, respectively, using laser welding by irradiating the optically-absorbing materials of the first end and the second end through the optically-transmissive material to form a welded joints, the welded joints maintaining the bipolar battery assembly in compression;
wherein the optically-absorbing material is optically absorbing within a specified range of wavelengths overlapping with a corresponding range of wavelengths over which the optically-transmissive material is optically transmissive, the specified range of wavelengths including an optical wavelength used for the irradiating the optically-absorbing material; and
wherein the first end defines a feature to mate with a corresponding portion of the first wall.

13. The bipolar battery assembly of claim 12, wherein the first and second ends comprise a first end segment and a second end segment, respectively, of a stack of the casing segments.

14. The bipolar battery assembly of claim 13, wherein the first and second end segments are fused to the stack of casing segments using respective joints separate from the welded joints formed between the first wall and the first and second ends.

15. The bipolar battery assembly of claim 14, wherein the respective joints fusing the first and second end segments to the stack comprise joints separate from the welded joints formed between the first wall and the first and second ends.

16. The bipolar battery assembly of claim 12, wherein the feature comprises at least one of a cavity or a protrusion.

17. The bipolar battery assembly of claim 12, wherein the feature defines at least one face on which a corresponding face of the portion of the first wall is mated; and
wherein a respective welded joint is formed at the mating faces using the laser.

18. The bipolar battery assembly of claim 12, wherein respective ones of the casing segments are hermetically isolated from each other by respective joints separate from the welded joints formed between first wall and the first and second ends of the bipolar battery assembly.

19. The bipolar battery assembly of claim 18, wherein the respective joints comprise respective seals.

20. The bipolar battery assembly of claim 12, wherein the first wall is amongst two or more side walls located on different sides of the battery assembly; and
wherein the two or more side walls maintain the bipolar battery assembly in compression using respective welded joints formed using laser irradiation.
